(19) United States
(12) Patent Application Publication
(10) Pub. No.: US 2025/0049041 A1
(43) Pub. Date: Feb. 13, 2025

(54) PEST CONTROL COMPOSITIONS CONTAINED IN PLASTIC CONTAINERS

(71) Applicant: The Procter & Gamble Company, Cincinnati, OH (US)

(72) Inventor: Michael David O'Young MUI, Mason, OH (US)

(21) Appl. No.: 18/795,597

(22) Filed: Aug. 6, 2024

Related U.S. Application Data
(60) Provisional application No. 63/518,735, filed on Aug. 10, 2023.

(51) Int. Cl. A01N 65/22; A01M 7/00; A01N 25/06; A01N 25/30; A01N 27/00; A01N 31/08; A01N 35/04; A01N 37/40; A01N 65/08; A01N 65/24; A01N 65/28; A01N 65/42; A01N 65/44; A01P 7/04

(52) U.S. Cl. CPC A01N 65/22; A01M 7/0017; A01N 25/06; A01N 25/30; A01N 27/00; A01N 31/08; A01N 35/04; A01N 37/40; A01N 65/08; A01N 65/24; A01N 65/28; A01N 65/42; A01N 65/44; A01P 7/04

(57) ABSTRACT

The present disclosure relates to improved pest control compositions and aerosol pest control products comprising the pest control compositions contained in plastic containers. The aerosol pest control product may comprise a spray dispenser connected to a pressurized plastic container and a pest control composition contained in the plastic container. The pest control composition may comprise from about 1 wt % to about 15 wt % of sodium lauryl sulfate; from about 0.005 wt % to about 15 wt % of an active ingredient, wherein the active ingredient is an essential oil; from about 0.1 wt % to about 45 wt % of a first solvent, wherein the first solvent is isopropyl alcohol; from about 45 wt % to about 99 wt % of water; and a propellant, preferably the propellant is selected from the group consisting of nitrogen, carbon dioxide, and mixtures thereof.

### CROSS REFERENCE TO RELATED APPLICATIONS

This application claims the benefit, under 35 U.S.C. § 119 (c), to U.S. Provisional Application No. 63/518,735, filed Aug. 10, 2023, the entire disclosure of which is fully incorporated by reference herein.

### FIELD

The present disclosure relates to improved pest control compositions and aerosol pest control products comprising the pest control compositions contained in plastic containers.

### BACKGROUND

The market for pest control products, such as weed control products and arthropod pest control products, is growing, and there is increasing consumer demand for pest control products containing natural ingredients, fewer ingredients, and/or recognizable ingredients. However, these products are still expected to be efficacious and efficiently control pests, such as weeds and arthropods, comparable to traditional chemical pest control or pesticide products.

There are existing pest control products and compositions that contain natural ingredients, such as plant essential oils. Some of these existing products have a number of disadvantages: some products may be messy to use and/or may leave a residue on a treated surface; some products may be unstable at cold temperatures (i.e., about 5° C. to 10° C.) or separate into multiple phases and require a consumer to vigorously shake the product before use; and some products have limited efficacy. Other products do not provide an optimal scent experience, e.g., emit a long-lasting, unpleasant odor. Still other products do not provide optimal aesthetics, e.g., appear cloudy, or turbid, and/or off color. More recently, efficacious pest control products comprising clear, aqueous pest control compositions, which contain plant essential oils, have been introduced. In particular, efficacious aerosol pest control products comprising clear, aqueous pest control compositions stored in pressurized containers have been introduced. The pressurized containers, which are well known in the art, are constructed of metal in order to withstand the internal pressure of aerosol products. A clear pressurized container may be desirable for storing a clear, aqueous pest control composition, as a clear container showcases the clear aesthetics of the composition and these clear aesthetics may connote purity. The most widely available clear pressurized containers are made of glass or certain types of plastic.

It has been found, however, that maintaining the clarity of a clear, aqueous pest control composition across a range of temperatures and in different types of clear containers, may be challenging. For example, some compositions may appear clear and single-phase at 25° C., but may phase separate into multiple phases or become turbid, when exposed to elevated (e.g., 40° C.) and/or reduced (e.g., 5° C.) temperatures, particularly when stored in glass containers. As such, there remains a need for aerosol pest control products that comprise single-phase, clear, aqueous pest control compositions stored in clear, pressurized containers, where the compositions maintain clarity and phase stability over a broad range of temperatures.

### SUMMARY

The present disclosure relates to an aerosol pest control product comprising: a. a spray dispenser connected to a pressurized plastic container having an internal gage pressure of from about 414 kPa to about 1,100 kPa; b. a pest control composition contained in the plastic container and comprising: i. from about 1% to about 15% by weight of the composition of sodium lauryl sulfate; ii. from about 0.005% to about 15% by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof; iii. from about 0.1% to about 45% by weight of the composition of a first solvent, wherein the first solvent is isopropyl alcohol; and iv. from about 45% to about 99% by weight of the composition of water; and v. a propellant chosen from nitrogen, carbon dioxide, or mixtures thereof.

Also described herein is an aerosol pest control product comprising: a. a spray dispenser connected to a pressurized plastic container having an internal gage pressure of from about 414 kPa to about 1,100 kPa; b. a pest control composition contained in the plastic container and comprising: i. from about 1% to about 15% by weight of the composition of sodium lauryl sulfate; ii. from about 0.005% to about 15% by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof; iii. from about 0.1% to about 45% by weight of the composition of a first solvent, wherein the first solvent is isopropyl alcohol; and iv. from about 45% to about 99% by weight of the composition of water; and v. a propellant chosen from nitrogen, carbon dioxide, or mixtures thereof. The pest control composition has a turbidity less than about 20 NTU and greater than about 0 NTU and a b* value of about 0 to about 5.

Also described herein is a method of controlling a pest comprising the steps of (i) providing a pest control product comprising: a. a spray dispenser connected to a pressurized plastic container having an internal gage pressure of from about 414 kPa to about 1,100 kPa; b. a pest control composition contained in the plastic container, wherein the pest control composition is an oil-water-emulsion comprising: i. from about 1% to about 15% by weight of the composition of sodium lauryl sulfate; ii. from about 0.005% to about 15%, by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof; iii. from about 0.1% to about 45% by weight of the composition of a first solvent, wherein the first solvent is isopropyl alcohol; iv. from about 45% to about 99% by weight of the composition of water; and v. a propellant chosen from nitrogen, carbon dioxide, or mixtures thereof; and (ii) dispensing the pest control product and contacting the pest with the pest control composition. The pest control composition exhibits a Spray D(90) of from about 100 microns to 900 microns after dispensing from the spray dispenser.

### DETAILED DESCRIPTION

It has been found that some aqueous pest control compositions, which contain certain natural active ingredients and high concentrations of water, when stored in glass containers, are not stable over a broad range of temperatures. “Stable” may refer to a pest control composition that is substantially clear and free from phase separation or precipitation, where no agitation or mixing is required to use the composition for its application. Surprisingly, when the same compositions are stored in glass containers, the compositions are unstable (particularly, at elevated temperatures). Generally, stability would be expected to be improved in a glass container. Surprisingly, though, the same aqueous pest control compositions are stable across a range of temperatures, when stored in clear plastic containers, particularly clear plastic containers made from polyethyleneterephthalate (“PET”).

The compositions of the present disclosure can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

### Pest Control Composition

The pest control products disclosed herein comprise compositions, preferably liquid compositions, more preferably aqueous liquid compositions, which may be housed within plastic containers. As used herein, “pest control” means the management of a pest species, including any animal, such as insects and other arthropods, plant, or fungus that adversely impacts human activities or the environment, where management includes controlling, killing, eliminating, repelling, or attracting the pest species. The terms “pest control” and “pesticide” are used interchangeably and it is understood that a composition or an ingredient that has “cidal” activity, e.g., pesticide, insecticide, herbicide, fungicide, may or may not kill and/or eliminate the target pest, e.g., arthropod, insect, weed, or fungus. As used herein, “cide” and “cidal” includes compositions, compounds, components, ingredients, materials, etc., which are effective to kill, remove, destroy, defoliate, exterminate, eradicate, eliminate, etc., a target pest, as well as to retard, regulate, inhibit, prevent, etc., the survival, growth, and/or proliferation of such pest.

Pest control products and compositions may include products and compositions for managing a pest species inside and outside of a building, such as a dwelling or a business, including, but not limited to, areas such as garages, patios, balconies, screened porches, lawns, and/or gardens. Pest control products and compositions may include products and compositions for use in and/or on yards, lawns, bushes, trees, and/or outdoor plants, as well as for use on or around indoor plants. Pest control products and compositions may include selective and non-selective products and compositions, such as selective and non-selective herbicides, fungicides, and insecticides. Pest control products and compositions may also include products and compositions for topical application to humans to control or repel pest species, such as insects and other arthropods.

The pest control compositions disclosed herein may comprise less than about 15 ingredients, preferably less than about 10 ingredients, more preferably less than about 15 ingredients and greater than about 5 ingredients.

The pest control compositions of the present disclosure may comprise renewable components. The compositions disclosed herein may comprise from about 1%, or from about 5%, or from about 10%, or from about 20%, or from about 30%, of from about 40%, or from about 50%, to about 40%, or to about 50%, or to about 60%, or to about 70%, or to about 80%, or to about 90%, or to about 100% by weight of renewable components. The compositions disclosed herein may be at least partially or fully bio-based, As such, the composition can comprise a bio-based carbon content of about 50% to about 100%, preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may comprise ingredients listed under section 25 (b) of the Federal Insecticide, Fungicide, and Rodenticide Act (FIFRA), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient. The compositions disclosed herein may comprise at least one ingredient that is food grade or generally recognized as safe (GRAS). The GRAS ingredient may include any agent listed on the FDA's GRAS list, including direct food additives (see, e.g., US law (sections 201 (s) and 409 of the Federal Food, Drug, and Cosmetic Act, November 2016). The GRAS ingredient may also include, but is not limited to, agents that are generally recognized, among experts qualified by scientific training and experience to evaluate their safety, as having been adequately shown through scientific procedures (or, in the case of a substance used in food prior to Jan. 1, 1958, through either scientific procedures or through experience based on common use in food) to be safe. The use of food grade or GRAS ingredients enables the compositions disclosed herein to be used by consumers without rinsing a treated surface after use. The compositions disclosed herein may comprise ingredients that have a tolerance or tolerance exemption for use on food contact surfaces under the Federal Food, Drug, and Cosmetic Act US law (see, e.g., 40 CFR 180, November 2016, December 2015 update).

### Water

Aqueous liquid compositions are convenient to use because these compositions can be readily applied directly to arthropod pests or weeds, while leaving minimal residue on adjacent surfaces. The pest control compositions may be substantially free of a geologically derived (e.g., petroleum-based) carrier oils, such as mineral oil, as products containing a carrier oil may be messy to use and may leave a residue on a treated surface.

The pest control compositions may comprise from about 40% to about 99% by weight of the composition of water. The pest control composition may comprise from about 40% to about 95%, or from about 50% to about 90%, or from about 55% to about 80%, or from about 58% to about 78%, or from about 60% to about 75%, or from about 62% to about 72% by weight of the total composition of water.

### Active Ingredients

The pest control composition may comprise one or more active ingredients (also referred to herein as actives). The pest control composition may comprise from about 0.005% to about 30%, or from about 0.05% to about 25%, or from about 0.15% to about 20%, or from about 0.5% to about 15%, or from about 1% to about 12%, or from about 2% to about 10% by weight of the composition of one or more active ingredients.

Nonlimiting examples of active ingredients include aldehyde C16 (pure), almond oil, terpenes, alpha-terpineol, verbenone, alpha-cedrene, cinnamic aldehyde, amyl cinnamic aldehyde, cinnamyl acetate, amyl salicylate, anisic aldehyde, citric acid, cedrol, benzyl alcohol, benzyl acetate, cinnamaldehyde, cinnamic alcohol, carvacrol, caryophyllene, carveol, citral, citronellal, methylheptenone, citronellol, dimethyl salicylate, eucalyptol (also known as 1,8-cineole), thujopsene, 3-thujopsanone, alpha-thujone, beta-thujone, fenchone, eugenyl acetate (e.g., isoeugenyl acetate), eugenol, iso-eugenol, methyl iso-eugenol, galaxolide, geraniol, guaiadiene, guaiacol, ionone, menthol (e.g., L-menthol), menthyl ester, menthone, carvone (e.g., L-carvone), camphor, camphene, p-cymene, borneol, bornyl esters, bornyl acetate, isobornyl acetate, terpinene (e.g., gamma-terpinene), methyl anthranilate, methyl ionone, methyl salicylate, nerol, phellandrene (e.g., alpha-phellandrene), pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, myrcene, chavicol, acetaldehyde, safrole, terpinen-4-ol, cineole, dimethyl trisulfide, diallyl disulfide, diallyl sulfide, diallyl tetrasulfide, 3-vinyl-[4H]-1,2-dithiin, thyme oil, thyme oil white, thyme oil red, thymol, anethole (e.g., trans-anethole), vanillin, ethyl vanillin, castor oil, cedar oil, cedarwood oil, cinnamon, cinnamon oil, citronella, citronella oil, clove, clove oil, corn oil, corn mint oil, oregano oil, cottonseed oil, garlic, garlic oil, geranium oil, lemongrass oil, linseed oil, mint, mint oil, peppermint, peppermint oil, spearmint, rose oil, spearmint oil, rosemary, rosemary oil, sesame, sesame oil, soybean oil, white pepper, licorice oil, wintergreen oil, anise oil (e.g., star anise oil), lilac flower oil, black seed oil, bay oil, grapefruit seed oil, grapefruit, lemon oil, orange oil, orange flower oil, tea tree oil, cedar leaf oil, camphor oil, Tagete minuta oil, lavender oil, Lippia javanica oil, oil of bergamot, galbanum oil, eucalyptus oil, lovage oil, and mixtures thereof.

The pest control composition may comprise about 0.005% to about 15%, preferably from about 0.05% to about 15%, more preferably from about 0.15% to about 12%, even more preferably from about 0.5% to about 10% of one or more active ingredients selected from the group consisting of eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), eucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, and mixtures thereof.

The pest control composition may comprise one or more synthetic pesticides. Nonlimiting examples of synthetic pesticides include pyrethroids, such as bifenthrin, esfenvalerate, fenpropathrin, permethrin, cypermethrin, cyfluthrin, deltamethrin, allethrin, lambda-cyhalothrin, or the like; syngergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. The pest control composition may comprise less than about 10%, or less than about 5%, or less than about 2%, or less than about 1%, or less than about 0.5%, or less than about 0.1% by weight synthetic pesticide. Alternatively, the pest control composition may be substantially free of synthetic pesticide.

The pest control composition may comprise one or more biopesticides. Nonlimiting examples of biopesticides include pyrethrum, rotenone, neem oil, and mixtures thereof.

The pest control composition may comprise from about 0.15% to about 15%, or from about 0.5% to about 15%, or from about 0.5% to about 15%, or from about 0.5% to about 10%, by weight of the composition of one or more active ingredients, where the active ingredient is an essential plant oil. The pest control composition may comprise one or more essential plant oils selected from the group consisting of corn mint oil, peppermint oil, spearmint oil, rosemary oil, thyme oil, citronella oil, clove oil, cinnamon oil, cedarwood oil, garlic oil, geranium oil, lemongrass oil, and mixtures thereof, preferably selected from the group consisting of corn mint oil, spearmint oil, rosemary oil, thyme oil, and mixtures thereof, more preferably selected from the group consisting of corn mint oil, rosemary oil, and combinations thereof.

### Surfactant

The pest control composition disclosed herein may be formulated with one or more surfactants. The pest control composition may comprise from about 0.01% to about 15%, or from about 0.1% to about 10%, or from about 1% to about 10%, or from about 1% to about 12.5%, or from about 1% to about 15%, or from about 1% to about 8% of one or more surfactants, preferably one or more anionic surfactants, more preferably sodium lauryl sulfate.

A sprayed drop of a pesticidal composition comprising an active agent is preferably able to wet a target surface and spread out or cover a target area to perform its intended function. A surfactant generally reduces the surface tension of the water on the surface of the spray drop by reducing the interfacial tension between the spray drop and target surface, e.g., exoskeleton of an arthropod. Surfactants also wet and disperse particles of active ingredient(s) in the composition prior to spraying, thereby enabling more uniform coverage and wetting of the target upon spraying. Surfactants may also function to emulsify active agents that are not easily solubilized in water, such as oils. Surfactants thus include various agents known to function as emulsifiers or wetting agents. Suitable surfactants include anionic surfactants, amphoteric surfactants, zwitterionic surfactants, nonionic surfactants, cationic surfactants, or mixtures thereof.

Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the allyl group (e.g., linear alkyl benzene sulfonates, such as dodecylbenzene sulfonate and salts thereof), alkyl sulfates and alkali metal salts thereof (preferably those having from about 8 to about 22 carbon atoms in the alkyl group, e.g., sodium dodecyl/lauryl sulfate), alkyl ether sulfates having from about 8 to about 22 carbon atoms in the alkyl group and about 2 to about 9 moles of ethylene oxide (e.g., sodium laureth sulfate). Aryl groups generally include one or two rings, alkyl groups generally include from about 8 to about 22 carbon atoms, and other groups generally comprise from about 1 to about 9 moles of ethylene oxide (EO) and/or propylene oxide (PO), preferably EO. A preferred anionic surfactant is sodium lauryl sulfate or SLS (also known as sodium dodecyl sulfate). The pest control composition may comprise from about 1% to about 10%, preferably from about 2% to about 8.5%, or from about 4% to about 8%, by weight of the composition of sodium lauryl sulfate.

Anionic surfactants also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts may be sodium, potassium, calcium, magnesium, barium, iron, ammonium and amine salts of fatty acids. The salts of fatty acids are also known as soaps. Fatty acid and the salts thereof may be linear, branched, saturated, unsaturated, cyclic, or mixtures thereof. Nonlimiting examples of fatty acids and salts thereof include octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Alternatively, the compositions may be substantially free of fatty acids, as a fatty acid may be difficult to solubilize in an aqueous composition. In particular, the compositions may be substantially free of lauric acid, oleic acid, stearic acid, or a combination thereof.

Additional suitable anionic surfactants include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines, sultaines, and lecithins. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alkyl sultaines, and alkylamidoalkylenchydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include the condensation products of alkyl phenols having from about 6 to about 12 carbon atoms with about 3 to about 100, or 3 to about 60, or 3 to about 30, or about 5 to about 14 moles of ethylene oxide. Nonionic surfactants also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280. Nonionic surfactants also include glyceryl esters, such as polyglyceryl oleate/stearate.

The pest control compositions of the present disclosure may optionally comprise one or more cationic surfactants. Suitable cationic surfactants include quaternary ammonium surfactants and amino surfactants that are positively charged at the pH of the pest control composition.

The weight ratio of surfactant, preferably anionic surfactant, more preferably sodium lauryl sulfate, to active ingredient may be from about 1:3 to about 30:1, or about 1:3 to about 20:1, or about 1:1 to about 20:1, or about 1:1 to about 10:1, or about 1:3 to about 3:1, or about 1:2 to about 2:1, or about 1:1.5 to about 1.5:1, or about 1:1.2 to about 1.2:1. The weight ratio of surfactant, preferably anionic surfactant, more preferably sodium lauryl sulfate, to lemongrass oil may be about 1:1 to about 30:1 or about 2:1 to about 30:1. The weight ratio of surfactant, preferably anionic surfactant, more preferably sodium lauryl sulfate, to active ingredient, preferably an essential oil or a constituent thereof, may be from about 1:1 to about 30:1 or about 1:1 to about 20:1.

### Solvent

The pest control compositions described herein may comprise from about 0.05% to about 45%, or from about 0.1% to about 30%, or from about 1% to about 25%, or from about 1% to about 20%, or from about 8% to about 15% by weight the composition of one or more solvents. Liquid pest control compositions may contain one or more solvents and water.

Suitable solvents include alcohols, such as monohydridic or polyhydridic alcohols. Preferred monohydridic alcohols are low molecular weight primary or secondary alcohols exemplified by ethanol, propanol, and isopropanol, preferably isopropanol. Polyhydridic alcohols, such as those containing from 2 to about 6 carbon atoms and from 2 to about 6 hydroxy groups (e.g., ethylene glycol, glycerine, and 1,2-propanediol (also referred to as propylene glycol)), may also be used.

Suitable solvents also include esters. The pest control composition may comprise from about 0.005% to about 15%, or from about 0.05% to about 12%, or from about 0.5% to about 10%, or from about 1% to about 7% by weight of the composition of one or more esters. Examples of suitable esters include triethyl citrate, diethyl citrate, monoethyl citrate, isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, PPG myristyl propionate, diglyceryl monooleate, and diglyceryl monostearate. The pest control composition may comprise triethyl citrate, preferably from about 0.005% to about 15%, or from about 0.05% to about 12%, or from about 0.5% to about 10%, or from about 1% to about 7% by weight of the composition of triethyl citrate.

Additional solvents include lipophilic fluids, including siloxanes, other silicones, hydrocarbons, glycol ethers, glycerine derivatives such as glycerine ethers, perfluorinated amines, perfluorinated and hydrofluorother solvents, low-volatility nonfluorinated organic solvents, diol solvents, and mixtures thereof.

Suitable solvents listed under section 25 (b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), and glycerine.

Preferred solvents include isopropanol, triethyl citrate, ethanol, glycerine, ethyl lactate, renewable versions thereof, and mixtures thereof. The pest control compositions described herein may comprise from about 1% to about 45%, or from about 1% to about 30%, or from about 1% to about 25%, or from about 1% to about 15% by weight the composition of a solvent selected from the group consisting of isopropanol, triethyl citrate, and mixtures thereof. The pest control compositions described herein may comprise from about 8% to about 20% by weight the composition of isopropanol. The pest control compositions described herein may comprise from about 0.3% to about 5%, preferably from about 0.3% to about 3% by weight the composition of glycerin.

### pH Adjusting Agents

The pest control compositions may comprise from about 0.00001% to about 1.5%, preferably from about 0.0001% to about 1%, more preferably from about 0.001% to about 0.8%, even more preferably from about 0.01% to about 0.6%, by weight of the composition of a pH adjusting agent, such as a carboxylic acid or a salt thereof selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof, more preferably citric acid anhydrous or citric acid monohydrate. The compositions described herein may comprise from about 0.00001% to about 1.5% by weight of the composition of citric acid or a salt thereof, such as sodium citrate, monosodium citrate, disodium citrate, trisodium citrate, trisodium citrate dihydrate, potassium citrate, monopotassium citrate, tripotassium citrate, tripotassium citrate monohydrate, or dipotassium citrate. Carboxylic acids, such as citric acid, or salts thereof may function to adjust the pH of the composition and/or as a chelant.

The pest control compositions may be subject to fluctuating temperatures during shipping, storage, and/or use. The pest control compositions is preferably stable at low temperatures (i.e., from about 5° C. to about 10° C.).

The pest control compositions may have a surface tension ranging from about 10 mN/m to about 60 mN/m, or from about 15 mN/m to about 50 mN/m, or from about 18 mN/m to about 40 mN/m, or from about 20 mN/m to about 30 mN/m, or from about 22 mN/m to about 28 mN/m, as measured according to the method described herein. It is believed that droplets may be preferred for delivering a targeted spray (particularly for non-selective herbicide compositions), while also sufficiently covering a target area.

The pest control compositions may comprise particles having an intensity mean particle size of from about 2 nm to about 500 nm, alternatively from about 4 nm to about 400 nm, alternatively from about 5 nm to about 100 nm. The composition may comprise particles having an intensity mean particle size of less than about 1 micron, preferably less than about 500 nm. Mean intensity particle size can be measured according to the Particle Size Test Method described hereafter.

The pest control composition may comprise particles having a volume mean particle size ranging from about 1 nm to about 100 nm, or from about 2 nm to about 50 nm, or from about 2 nm to about 25 nm, or from about 2 nm to about 10 nm. The composition may comprise particles having a volume mean particle size of less than about 1 micron, preferably less than about 500 nm. Mean volume particle size can be measured according to the Particle Size Test Method described hereafter. Volume mean particle size may be selected to provide a transparent or translucent composition, as well as to efficiently deliver an active agent to the target surface or area.

The pest control compositions may have a NTU value less than about 200, or less than about 100 or from about 0.5 to about 50, or from about 1 to about 25. A composition having a NTU value in the disclosed ranges may be perceived by a consumer as being clear, transparent, or translucent, which may connote purity, quality, and/or that the composition is not likely to stain surfaces.

The CIELAB color scale (according to ASTM D5386-93b may be used to quantify the color of an arthropod pest control composition. The CIELAB color scale may also be referred to as L*a*b*, a color scale defined by the International Commission on Illumination (abbreviated CIE) in 1976. The CIELAB color scale expresses color as three values: L* for perceptual lightness, and a* and b* for the four unique colors of human vision: red, green, blue, and yellow, where the b* value represents blue/yellow color. The composition may have a b* value form about 0 to about 5, or from about 0.01 to about 4, or from about 0.05 to about 3.5, or from about 0.1 to about 3. A composition with a b* value according to the disclosed ranges may be perceived by a consumer as having a colorless appearance, while b* values outside the disclosed ranges, especially b* values greater than 5, may appear yellow to a consumer, which may connote that the composition contains impurities, has degraded, and/or is unsuitable for use.

The pest control compositions may have a Brookfield viscosity ranging from about 1 cps to about 500 cps, or from about 1 cps to about 300 cps, or from about 1 cps to about 200 cps, or from about 1 cps to about 100 cps, or from about 2 cps to about 100 cps, or from about 3 cps to about 50 cps, as measured according to the method described herein. The Brookfield viscosity may enable the aerosol dispensing device to dispense the composition as droplets. For some products, such as pesticide products, droplets may be preferred, particularly versus a mist, a stream, or a foam.

The pest control composition may comprise: (a) from about 0.5% to about 12%, preferably about 1% to about 10%, more preferably about 2% to about 8.5%, even more preferably about 3% to about 7.5%, by weight of the composition of sodium lauryl sulfate; (b) from about 0.5% to about 15%, preferably about 1% to about 10%, more preferably about 1.5% to about 8%, by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof, preferably selected from the group consisting of geraniol, cornmint oil, peppermint oil, rosemary oil, lemongrass oil, and mixtures thereof; and (c) from about 60% to about 90%, preferably about 65% to about 85%, more preferably about 70% to about 80%, by weight of the composition of water.

The pest control composition may optionally further comprise from about 0.5% to about 10%, preferably from about 1% to about 5%, by weight of the composition of by weight of the composition of urea. The pest control composition may optionally further comprise from about 0.1% to about 45%, preferably from about 0.5% to about 35%, more preferably from about 1% to about 25%, even more preferably from about 2% to about 20%, by weight of the composition of by weight of the composition of a solvent selected from the group consisting of isopropyl alcohol, triethyl citrate, isopropyl myristate, ethyl lactate, butyl lactate, butyl stearate, glycerin, and mixtures thereof, preferably selected from the group consisting of isopropyl alcohol, triethyl citrate, and mixtures thereof. The pest control composition may also optionally further comprise a carboxylic acid or salt thereof selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof. The pest control composition may also optionally further comprise an ingredient selected from pH adjusting agents, propellants, preservatives, thickeners, fatty acids or salts thereof, and combinations thereof.

The pest control composition may be provided in the form of a concentrated composition, which is mixed with a diluent, e.g., water, prior to use, or a ready-to-use composition, which can be directly applied to weeds (e.g., as a spray) and need not be diluted by a consumer before use. Ready-to-use compositions may be preferred by some consumers, because ready-to-use compositions do not require dilution by the consumer, which may be messy, inconvenient, and/or require multiple containers. The pest control composition may contain select ingredients at select levels suitable to be sprayed directly onto pests.

The pest control composition may be an oil-in-water emulsion. The pest control composition may have a turbidity less than about 20 NTU, a b* value of about 0 to about 5, or a combination thereof.

The pest control composition may have a pH ranging from about 3.0 to about 11.0, or from about 4.0 to about 11.0, or from about 4.0 to about 9.0, or from about 5.0 to about 9.0, or from about 5.0 to about 8.0, or from about 6.0 to about 8.0, or from about 6.0 to about 7.0.

The pest control composition may be a “low VOC” composition and comprise about 3% volatile organic compounds (VOCs) by weight or less. Alternatively, the pest control composition may comprise greater than 3% volatile organic compounds (VOCs) by weight. The pest control composition may comprise greater than 3% to about 35% by weight of volatile organic compound (VOC). It may be desirable to keep the total level of VOCs in the pest control composition to less than or equal to about 3% by weight. VOCs can be measured according to the California Air Resources Board (CARB) Method 310 for VOC determination (May 25, 2018).

Aqueous pest control compositions are described in U.S. application Ser. No. 17/865,943, U.S. application Ser. No. 18/082,891, U.S. application Ser. No. 18/334,004, and U.S. Provisional App. Ser. Nos. 63/509,339 and 63/509,380, all of which are hereby incorporated by reference herein. Suitable herbicide compositions may also comprise from about 40% to about 99% by weight of the composition of water and are described in WO App. Ser. No. PCT/US23/68554 and U.S. Provisional App. Ser. No. 63/355,134, which are hereby incorporated by reference herein.

### Plastic Container

The aqueous pest control compositions of the present disclosure have been found to be compatible with and useful to store in clear, pressurized plastic containers or bottles. “Plastic” refers to any synthetic or organic material that can be molded or shaped, generally when heated, and then hardened into a desired form including, but not limited to, polymer, resin, and cellulose derivative. The plastic may be polymeric and may be partially, substantially, or entirely comprised of polyester; polyethyleneterephthalate (“PET”); polyethylene napthalate, polyethylene furanoate, polyamide; nylon 6/6, nylon 66, nylon 11, polycarbonate; polyoxymethylene; polyacrylonitrile; polyolefin; polyethylene, polypropylene, fluoropolymer; poly(butylene succinate); virgin, recycled, and regrind versions of the other polymer materials; bio-based and petroleum-based versions of the other polymer materials; and mixtures thereof. The plastic container may comprise multiple layers of other polymer materials. By polymeric it is meant that the component is formed of a material which is plastic, comprises polymers, and/or particularly polyolefin, polyester or nylons. Thus, the entire plastic container or, specific components thereof, may be free of metal, allowing for exposure to microwave energy. Plastic materials that may be used include, but are not limited to: polypropylene (PP), polyethylene (PE), polycarbonate (PC), polyamides (PA) and/or polyethylene terephthalate (PET), polyvinylchloride (PVC); and polystyrene (PS). Polyethylene terephthalate (PET) is preferred.

The plastic container may be pressurized to an internal gage pressure of about 345 kPa (55 psi) to about 1100 kPa, or from about 414 kPa to about 1100 kPa, or from about 460 kPa to about 1100 kPa, or from about 480 kPa to about 1100 kPa, or from about 500 to about 1100 kPa, or from about 550 kPa to about 1100 kPa, or from about 600 kPa to about 1100 kPa, or from about 690 kPa (100 psi) to about 1100 kPa, or about 827 kPa (120 psi) to about 1100 kPa, or 935 kPa (135 psi) to about 1100 kPa, or from about 600 kPa to about 1,000 kPa, or from about 700 kPa to about 900 kPa.

A plastic container having a crystallized neck may be pressurized to an internal gage pressure of up to 1300 kPa, preferably 345 kPa to 1300 kPa, or 414 kPa to about 1100 kPa, or from about 460 kPa to about 1100 kPa, or from about 480 kPa to about 1100 kPa, or from about 500 to about 1100 kPa, or from about 550 kPa to about 1100 kPa, or from about 600 kPa to about 1100 kPa, or from about 690 kPa (100 psi) to about 1100 kPa, or about 827 kPa (120 psi) to about 1100 kPa, or 935 kPa (135 psi) to about 1100 kPa or preferably from about 460 kPa to about 1100 kPa. The final gage pressure of the plastic container is 0 when the propellant is fully discharged from the container. Where residual aqueous pest control composition remains, the final gage pressure may be from about 0 to about 120 kPa. A suitable pressurized plastic aerosol container is disclosed in U.S. application Ser. No. 15/627,479, published as US Patent Publication No. 2017/0360978A1, which is incorporated herein by reference.

The pressurized plastic container includes a propellant. Any suitable propellant may be used. The propellant may comprise a compressed gas such as, nitrogen, carbon dioxide, compressed air, and mixtures thereof. The propellant may comprise a liquefied hydrocarbon gas, such as butane, isobutate, and propane, or a hydrofluoro olefin (“HFO”). If a liquefied gas propellant is used, the pressurized plastic container may include a bag-in-bottle configuration. Propellants listed in the U.S. Federal Register 49 C.F.R. § 1.73.115, Class 2, Division 2.2 are considered acceptable. The propellant may comprise a trans-1,3,3,3-tetrafluoroprop-1-ene, and optionally a CAS number 1645-83-6 gas. One such propellant is commercially available from Honeywell International of Morristown, New Jersey under the trade name HFO-1234ze or GWP-6. The propellent may be selected from the group consisting of nitrogen, carbon dioxide, and mixtures thereof.

If desired, the propellant may be condensable. By “condensable”, it is meant that the propellant transforms from a gaseous state of matter to a liquid state of matter in the container and under the pressures encountered in use. Generally, the highest pressure occurs after the container is charged with product but before that first dispensing of that product by the user. A condensable propellant provides the benefit of a flatter depressurization curve as product is depleted during usage.

The volumetric ratio of aqueous pest control composition to propellant may be in the range of about 40/60 to about 70/30, alternatively in the range of about 50/50 to about 60/40. The aqueous pest control composition is delivered from the pressurized plastic container 10, which includes delivery components including but not limited to a valve to control flow and to seal the composition within the pressurized plastic container, a button actuator and a nozzle for dispensing the composition to the environment. The aqueous pest control composition may contact the inner face of the plastic container 10 and is not contained in a plastic container by a bag-in-can or a plastic container comprising a liner. In other embodiments, the aqueous pest control composition may be contained in a bag-in-can or bag-in-bottle plastic container.

The pressurized plastic container may hold from about 20 grams to about 500 grams, or from about 20 grams to about 300 grams, or from about 50 g to about 500 g, or at least about 20 grams, or at least about 120 grams, or at least about 130 grams, or at least about 150 grams of the pest control composition.

A transparent or translucent pressurized plastic container may have a light transmittance of greater than 25% at wavelength of about 410-800 nm. A transparent or translucent plastic container may have a light transmittance of more than about 25%, or more than about 30%, or more than about 40%, or more than about 50% in the visible part of the spectrum (approx. 410-800 nm). Alternatively, absorbency of the plastic bottle may be measured as less than about 0.6 or by having transmittance greater than about 25%, where % transmittance equals:

$$\frac{1}{{10}^{absorbancy}} \times 100 \%$$

For purposes of the disclosure, as long as one wavelength in the visible light range has greater than about 25% transmittance, it is considered to be transparent/translucent.

The plastic container may store from about 50 g to about 500 g, or from about 150 g to about 400 g, or from about 200 g to about 350 g, of the composition. The weight of the pest control product, including the composition, is preferably selected to enable a user to comfortably manipulate and actuate the product with one hand, while providing enough composition to treat one or multiple target areas/surfaces of varying sizes, once or multiple times, e.g., multi-use product (e.g., a multi-use product).

### Spray Characteristics

As detailed below, in the Spray Droplet Size Test Method, spray droplet volume size distribution measurements comprising Spray D(50) Normalized, Spray D(90) Normalized, and Spray D(2,3) Normalized values are determined using a Malvern Spraytec 2000 laser diffraction spray droplet sizing instrument (supplied by Malvern Instruments, Worcestershire, UK). The pest control compositions, when dispensed through aerosol spray dispensers, may have a Spray D(90) ranging from about 100 microns to 900 microns, or from about 125 microns to about 800 microns, or from about 150 microns to about 700 microns. Spray D(90) may be selected to efficiently deliver an active agent to the target surface or area. Also, a Spray D(90) in the disclosed ranges may be perceived as capable of traveling a distance of one or more meters and depositing on a target surface. Particles having a Spray D(90) less than 100 microns may create a spray that is too misty or a spray that does not have sufficient velocity to travel to a target surface.

The aerosol spray dispenser may have a spray rate ranging from about 0.5 g/s to about 5 g/s, or from about 0.75 g/s to about 4 g/s, or from about 1.25 g/s to about 3.5 g/s, or from about 1.5 g/s to about 3 g/s. The spray rate may be selected to enable targeted dispensing and delivery of the composition, without over-spraying or spraying composition outside the target area.

Without being bound by theory, it is believed that the aerosol pest control products disclosed herein are particularly advantageous for the targeted spraying of pest control compositions ((e.g., insecticide or herbicide) from a distance of about 0.3 m to about 1.5 m, preferably about 0.3 m to about 1 m, from the target pest or surface. The composition (including characteristics such as viscosity and surface tension), the dispensing pressure, and/or the nozzle design may be selected to provide optimal spray exit velocity and particle size distribution (PSD) for spraying a pest control product on the target pest or surface at a distance of about 0.3 m to about 1.5 m, preferably about 0.3 m to about 1 m, from the target pest or surface.

### Methods for Controlling Weeds

The present invention also relates to methods for controlling undesired weeds. In some aspects, the method for controlling weeds can comprise the steps of: (a) providing a pest control composition (e.g., an herbicide composition); and (b) contacting the weeds with an effective amount of the pest control composition. The pest control composition may be applied (e.g., by spraying as an aqueous liquid) onto a target area in an amount in the range of from about 0.5 to about 40 ml/ft, alternatively from about 0.9 to about 36 ml/ft.

The pest control composition, e.g., herbicide, may be used to inhibit the growth and/or development of weeds, such as for example dandelion, milk thistle, broadleaf plantain, white clover, green foxtail, redroot pigweed, yellow nutsedge, crabgrass, evening primrose, chickweed, common bermudagrass, morning glory, wild carrot, Italian ryegrass, umbrella sedge, or ivy. The pest control composition, e.g., herbicide, may be sprayed onto the leaves of target weeds. The pest control composition, e.g., herbicide, may be used to treat existing weeds or may be used prevent weed growth. In the latter case, the pest control composition, e.g., herbicide, may be used as a pre-emergent pest control.

The pest control composition, e.g., herbicide, may be used to control weeds that grow from a variety of surfaces. For example, the pest control composition, e.g., herbicide, may be sprayed on hard surfaces with openings containing dirt where weeds may be present or may develop, such as asphalt, concrete, interlocking bricks, roads, and highways. The pest control composition, e.g., herbicide, may be applied to lawns, golf course greens, or flower beds, where weeds may be present or may develop.

The pest control composition, e.g., herbicide, may be applied as a single treatment or as multiple treatments, such as application on consecutive days or weeks.

### Method of Controlling an Arthropod Pest

The present invention also relates to methods for controlling undesired arthropods, such as insects. In some aspects, the method of controlling an arthropod pest may comprise the steps of: (i) providing a pest control composition (e.g., an insecticide composition); (ii) contacting the arthropod pest with the pest control composition(s) as described herein; (iii) optionally wiping any excess pest control composition from an adjacent surface(s). The arthropod pest may be contacted with an effective amount of the pest control composition. The optional wiping of an adjacent surface(s) may provide a cleaning benefit on the surface, due to the presence of a surfactant, such as sodium lauryl sulfate, in the composition. Optionally, the adjacent surface may be left to dry, without wiping or rinsing.

The pest control composition, e.g., insecticide, may be applied as a single treatment or as multiple treatments, such as application on consecutive days or weeks.

### Test Methods

### Brookfield Viscosity

Brookfield viscosity is measured at 23° C.±2° C. using a Brookfield DV-E viscometer. The liquid is contained in a glass jar, where the width of the glass jar is from about 5.5 to 6.5 cm and the height of the glass jar is from about 9 to about 11 cm using spindle LV2 at 60 RPM. The test is conducted in accordance with the instrument's instructions.

### pH Test Method

pH can be using a standard pH meter such as, for example, a Beckman Coulter model PHI1410 pH meter equipped with a general-purpose probe (manufactured by Beckman Coulter, Brea, California, U.S.A.). The pH meter is calibrated according to the manufacturer's instructions. Measurements are performed after storing the compositions at room temperature (approximately 23° C.±2° C.) for approximately 24 hours.

### Particle Size Test Method

Particle size is measured by light scattering data techniques. Particle size is determined with a Malvern Zetasizer Nano ZSP (Malvern Panalytical, Malvern, United Kingdom), or the like. The software used for control of the instrument and for data acquisition is the Malvern Zetasizer Software version 8.01.4906 (Malvern Panalytical). All samples are kept at 25° C., unless otherwise specified.

Samples are measured in BRAND® polystyrene disposable cuvettes (Cat. No. 759070D or equivalent). 1 mL of the sample is added into the cuvette using a disposable transfer pipette (VWR, Cat. No. 414004-004 or equivalent), swirled, and then discarded. Another 1 mL of the sample is added into the cuvette using a disposable transfer pipette. The cap is placed on the cuvette and all sides of the cuvette are wiped with lint-free lens paper. The cuvette is loaded into the instrument in accordance with the manufacture's specification to ensure light is passing correctly into the sample during the measurement, and the lid is closed.

The instrument is readied in accordance with manufacture's specification. The particle size measurements are made through the software with the following settings:
1) Under the ‘Measure’ section, the ‘Manual’ option is selected. ‘Measurement Type’ is then set to ‘Size’.
2) The ‘Sample’ section is then selected. In the ‘Material’ subsection: ‘Material’ is chosen to be ‘SDS’; the ‘RI’ is set to 1.461; and the ‘Absorption’ is set to 0.001. In the ‘Dispersant’ subsection: ‘Dispersant’ is selected as ‘Water’; ‘Temperature’ is set to 25.0 deg C.; ‘Viscosity’ is set at 0.8872 cP; and ‘RI’ is set as 1.330. In the ‘General options’ subsection ‘Mark-Houwink Parameters’ is selected, ‘A Parameter’ is set to 0.428; and ‘K Parameter (cm2/s)’ is set to 7.67e-05. In the ‘Temperature’ subsection: ‘Temperature’ is set as 25.0 deg C.; ‘Equilibration Time (second)’ is set to 120. In the ‘Cell’ subsection: ‘Cell Type’ is selected to be ‘Disposable cuvettes’; and the ‘DTS0012’ option is selected.
3) The ‘Measurement’ section is then selected. The ‘Angle of Detection Measurement Angle’ is selected as ‘1730 Backscatter (NIBS default)’; ‘Measurement Duration’ is selected as ‘Automatic’; ‘Number of Runs’ is set to 11; ‘Run duration (seconds)’ is set to 10; ‘Number of Measurements’ is set as 3; ‘Delay between Measurements (seconds)’ is set to 0; ‘Append Measurement Number to Sample Name’ is selected; and ‘Allow Results to be Saved Containing Correlation Data Only’ is not selected. In the ‘Advanced’ subsection: ‘Measurement duration, Extend Duration for Large Part’ is set to ‘No’; ‘Measurement settings, Positioning method’ is set to ‘Seek for Optimum Position’; and Automatic attenuation selection is set to ‘Yes’.
4) The ‘Data Processing’ section is then selected, and the following options are selected: ‘Analysis Model’ is selected as ‘General Purpose (Normal Resolution)’. The ‘Size Analysis Parameters’ are set to: ‘Analysis Details’; ‘Name’ is set to ‘Customized’, ‘Description’ is set to ‘Customized Analysis’; ‘Display Range’ is set with the ‘Lower Limit’ set to 0.6 and ‘Upper Limit’ set to 6000; ‘Multimodal-analysis, Resolution’ is selected to ‘Normal’; ‘Size classes, Number of size classes’ is set as 70; ‘Lower Size Limit’ is set as 0.4; ‘Upper Size Limit’ is set as 10,000; ‘Lower Threshold’ is set as 0.05; and ‘Upper Threshold’ is set as 0.01. In the ‘Reports’ subsection: ‘Print Report’ is not selected and in the ‘Export’ subsection: ‘Export’ results is not selected.

### Spray Droplet Size Test Method

The term “Dv10 value” describes the average particle size where 10 vol. % of the particles have a smaller size. Similarly, the term “Dv50 value” describes the average particle size where 50 vol. % of the particles have a smaller size, and the term “Dv90 value” describes the average particle size where 90 vol. % of the particles have a smaller size. The Sauter mean diameter (D [3, 2]) is the weighted average surface diameter, assuming spherical particles of the same surface area as the actual particles:

$$D [ 3 , 2 ] = \frac{\sum {D}_{i}^{3} {n}_{i}}{\sum {D}_{i}^{2} {n}_{i}} .$$

Spray droplet volume size distribution measurements comprising Spray D(50) Normalized, Spray D(90) Normalized, and Spray D(2,3) Normalized values are determined using a Malvern Spraytec 2000 laser diffraction spray droplet sizing instrument (supplied by Malvern Instruments, Worcestershire, UK), equipped with a 300 mm lens possessing a focal length of the 150 mm, and an Air Purge System (not greater than 14.5 psi). The system is controlled with a computer and software accompanying the instrument, such as the Spraytec software version 3.20 or equivalent, utilizing Mie Theory and Fraunhofer Approximation optical theory. The system is placed in a fume hood for atmospheric control with care taken to place it directly opposite the actuation spray plume trajectory to prevent saturation, with an air flow rate of between 50-70 L/min (60 L/min was the target rate). The distance from the dispensing nozzle orifice to the laser during measurements is 30 cm. A new spray bottle is used for each sample replicate analyzed. Lighting conditions are not changed during or between the background control and test sample data collection periods. Light obscuration values below 95% are considered suitable to provide accurate results.

Samples analyzed included “example” samples, which are samples according to this disclosure, and comparative samples. All newly created example samples are tested within three hours of preparation and are measured at temperatures between 20-22° C. Deionized water is used as a standard reference spray and is labeled as the “control.”

Spray measurements are conducted using the following spray SOP instrument configuration: Rapid SOP type is chosen, and the following settings are selected: Hardware Configuration is set to “Default”, Measurement Type is set to “Rapid”, Data Acquisition Rate is set to “250 Hz”, and Lens Type is set to “300”. Within the Measurement menu: Background is set to “3 seconds”, Inspection is selected, the box under Output Trigger is Unchecked. Under the Measurement tab “Rapid” is selected, Events Number is set to “1”, Duration Per Event is set to “4000.0”, Units is set to “ms”. Measurement Trigger where Trigger Type is set to “Transmission drops to level” and Transmission is set to “96”, Data Collection where Start is set to “52”, Units is set to “ms”, and select “before the trigger” from the drop down menu. On the Advanced tab window, all boxes are Unchecked, and Grouping is “no grouping”; The Background Alarms are set to “default values”. On the Analysis Tab and under Optical Properties, Particle Set is set to “Water”, Dispersant set to “Air”, Multiple Scattering Analysis is set to “Enable”. On the Data Handling tab and under Detector Range is set to “first: 1 and last: last”, “No extinction analysis” box is selected, Scattering threshold is set to “1”. On the Data Handling/Spray Profile the Path Length is set to “100.0”, the Alarm is selected, and the “Use default values” box is checked. On the Additional Properties tab the Curve Fit is set to “no fit”, User Size is set to “enable box”, the drop down menu is set to “Default”. On the Additional Properties/Advanced tab Particle Diameter is set to “0.10” for the minimum and to “900” for the maximum, and Result Type is set to “Volume Distribution”. On the Output tab, Export Option is set to “not selected”, the Derived Parameter is selected, the Use Averaging Period box is selected and set to “0.0” and “ms”. On the Average menu “Average scatter data” is selected.

Spray measurements are conducted using the following Spray Procedure: The sample is first test sprayed from the spray bottle for 1-2 seconds, to ensure that the nozzle is free flowing and not clogged; the sample is loaded into the holding device in the front of the Spraytec 2000 system. The actuator is fully depressed. The spray droplet size data are viewed and saved as “Average Scatter Data”.
a. The value obtained from each sample measurement is normalized to the control sample value in accordance with the following calculations:

The value of Spray D(50) Normalized=D(50)_{Example}/D(50)_{Control};

The value of Spray D(90) Normalized=D(90)_{Example}/D(90)_{Control};

The value of Spray D(3,2) Normalized=D(3,2)_{Example}/D(3,2)_{Control};

wherein:

Spray D(50), Spray D(90), and Spray D(3,2) are values obtained from the instrument software for both the example samples and control samples separately.

Each of the Spray D(90) Normalized and Spray D(3,2) Normalized values reported for each of the samples is the average value calculated from five replicate spray plumes per sample.

### Determination of the Hunter L.a.b. (CIE) b* Value

The formation of yellow color is measured using the Hunter L.a.b. (CIE) method. The b* value is determined using a HunterLab ColorFlex EZ® spectrophotometer (HunterLab, 11491 Sunset Hills Road, Reston, Virginia 20190). The methodology that is used is described in detail in the “User's Manual for ColorFlex EZ Version 2.2.”

The HunterLab ColorFlex EZ® spectrophotometer uses a xenon flash lamp to illuminate a sample. The light reflected from the sample is then separated into its component wavelengths through a dispersion grating. The relative intensities of the light at different wavelengths along the visible spectrum (400-700 nm) are then analyzed to produce a number result indicative of the color of the sample.

### Turbidity Method

A turbidimeter is used to measure the turbidity of the compositions. This instrument measures the turbidity of liquids in Nephelometric Turbidity Units (NTU). The method of measuring turbidity is described in detail in the following reference: Hach 2100Q and 2100Qis User Manual, Edition 6, 08/2021, from the Hach Company. If a sample is not homogenous prior to analysis, the sample is inverted until it appears homogenous and is then poured into an analyte vile for measurement.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Surface Tension Method

Surface tension is measured according to ASTM 1331-14 (Published January 2015) using an EZ-Pi tensiometer (Kibron, Parrish, Fla.), or equivalent. The instrument is calibrated according to the manufacturer instructions using DI water. Measurements are taken and values are reported in mN/m.

Temperature Stability Method Samples are prepared by combining all composition ingredients in a 4-ounce glass vial or a 10-ounce plastic (PET) bottle at ambient conditions (25 deg. C.). Each sample is mixed and five minutes after mixing is completed, the sample is observed for initial stability.

Cold temperature cycle stability is measured by filling a 4-ounce glass vial or a 10-ounce plastic (PET) bottle with a sample composition. The vial or bottle is sealed and stored at 5° C. for 12 to 14 hours. The vial or bottle is then moved to a 25° C. environment and stored for 10 to 12 hours, thereby completing one cold temperature cycle. This is repeated two more times, for a total of three cold temperature cycles. After the final incubation at 25° C., the vials and bottles are visually observed for stability (and may be assessed for turbidity and b* value using the Turbidity and Hunter L.a.b. (CIE) method described above).

### EXAMPLES

Formulations A-E are in Table 1 are formulated and tested to study turbidity, when stored in a glass container and when stored in a plastic container.

TABLE 1

| | A | B | C | D | E |
|---|---|---|---|---|---|
| Sodium Octanoate | 1.0 | 1.0 | 1.0 | 1.0 | 1.0 |
| SLS | 3.5 | 3.5 | 3.5 | 3.5 | 3.5 |
| Citric Acid | 2.34 | 0.68 | 1.85 | 0.665 | 0.34 |
| Oleic Acid | 0.15 | 0.15 | 0.15 | 0.15 | 0.15 |
| Cornmint Oil | 1.26 | 1.26 | 1.26 | 1.26 | 1.26 |
| Rosemary Oil | 0.80 | 0.80 | 0.80 | 0.80 | 0.80 |
| Peppermint Oil | 0.14 | 0.14 | 0.14 | 0.14 | 0.14 |
| Triethyl Citrate | 2.4 | 2.4 | 2.4 | 0.60 | 2.4 |
| IPA | 13.0 | 13.0 | 7.5 | 7.5 | 13.0 |
| Glycerin | 0.50 | 0.50 | 0.50 | 0.50 | 0.50 |
| Sodium Citrate | 0.92 | 0.25 | 0.92 | 0.125 | 0.25 |
| Water | QS | QS | QS | QS | QS |
| pH | 4.0 | 5.0 | 4.0 | 5.0 | 6.0 |

TABLE 2

| | A | A | B | B | C | C | D | D | E | E |
|---|---|---|---|---|---|---|---|---|---|---|
| Container | Glass | PET | Glass | PET | Glass | PET | Glass | PET | Glass | PET |
| Material | | | | | | | | | | |
| Propellant | No | Yes | No | Yes | No | Yes | No | Yes | No | Yes |
| (Nitrogen) | | | | | | | | | | |
| Gauge | 0 | 860 | 0 | 860 | 0 | 860 | 0 | 860 | 0 | 860 |
| Pressure | | | | | | | | | | |
| (KPa) | | | | | | | | | | |
| Phase Stable | No | Yes | No | Yes | No | Yes | No | Yes | No | Yes |
| after 2 weeks | | | | | | | | | | |
| at 54° C. | | | | | | | | | | |

### Combinations

Paragraph 1. An aerosol pest control product comprising:
a. a spray dispenser connected to a pressurized plastic container having an internal gage pressure of from about 414 kPa to about 1,100 kPa;
b. a pest control composition contained in the plastic container and comprising:
   i. from about 1% to about 15% by weight of the composition of sodium lauryl sulfate;
   ii. from about 0.005% to about 15%, preferably from about 0.15% to about 10%, by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof, preferably selected from the group consisting of geraniol, cornmint oil, peppermint oil, spearmint oil, rosemary oil, lemongrass oil, and mixtures thereof;
   iii. from about 0.1% to about 45% by weight of the composition of a first solvent, wherein the first solvent is isopropyl alcohol; and
   iv. from about 45% to about 99%, preferably from about 50% to about 95%, by weight of the composition of water; and
   v. a propellant, preferably the propellant is selected from the group consisting of nitrogen, carbon dioxide, and mixtures thereof.
      Paragraph 2. The aerosol pest control product according to paragraph 1, wherein the container is transparent or translucent, preferably the container has a light transmittance of greater than about 25% at a wavelength of about 410 nm to about 800 nm.
      Paragraph 3. The aerosol pest control product according to any one of Paragraphs 1-2, wherein the pest control composition further comprises from about 0.1% to about 10% by weight of the composition of a second solvent selected from the group consisting of triethyl citrate, isopropyl myristate, propylene carbonate, ethyl lactate, butyl lactate, butyl stearate, glycerin, and mixtures thereof, preferably glycerin, more preferably from about 0.1% to about 5% by weight of the composition of glycerin.
      Paragraph 4. The aerosol pest control product according to any one of Paragraphs 1-3, wherein the pest control composition comprises from about 0.5% to about 10% by weight of the composition of an active ingredient selected from the group consisting of geraniol, cornmint oil, peppermint oil, rosemary oil, lemongrass oil, and mixtures thereof, preferably geraniol.
      Paragraph 5. The aerosol pest control product according to any one of Paragraphs 1-4, wherein the weight ratio of sodium lauryl sulfate to active ingredient is from about 1:1 to about 20:1.
      Paragraph 6. The aerosol pest control according to any one of Paragraphs 1-5, wherein the composition comprises from about 0.15% to about 15% by weight of the composition of an active ingredient selected from the group consisting of geraniol, cornmint oil, lemongrass oil, rosemary oil, and mixtures thereof.
      Paragraph 7. The aerosol pest control product according to any one of Paragraphs 1-6, wherein the composition comprises from about 0.5% to about 5% by weight of the composition of cornmint oil.
      Paragraph 8. The aerosol pest control product according to any one of Paragraphs 1-7, wherein the composition further comprises a carboxylic acid selected from the group consisting of citric acid, malic acid, acetic acid, fumaric acid, humic acid, salts thereof, and mixtures thereof.
      Paragraph 9. The aerosol pest control product according to any one of Paragraphs 1-8, wherein the composition has a pH of about 3 to about 9.
      Paragraph 10. The aerosol pest control product according to any one of Paragraphs 1-9, wherein the composition has a turbidity less than about 20 NTU and greater than about 0 NTU, preferably less than about 10 NTU and greater than about 0 NTU.
      Paragraph 11. The aerosol pest control product according to any one of Paragraphs 1-10, wherein the composition has a b* value of about 0 to about 5.
      Paragraph 12. The aerosol pest control product according to any one of Paragraphs 1-11, wherein the composition comprises particles having an intensity mean particle size or volume mean particles size from about 2 nm to about 100 nm, as measured according to the Particle Size Test

### Method.

Paragraph 13. The aerosol pest control product according to any one of Paragraphs 1-12, wherein the composition comprises from about 3% to about 35% by weight of volatile organic compound (VOC).
Paragraph 14. The aerosol pest control product according to any one of Paragraphs 1-13, wherein the composition is substantially free of synthetic pesticides, mineral oil, colorants, antifoam agents, or a combination thereof.
Paragraph 15. The aerosol pest control product according to any one of Paragraphs 1-14, wherein the active ingredients are food use safe, preferably all the ingredients are food use safe.
Paragraph 16. The aerosol pest control product according to any one of Paragraphs 1-15, wherein the plastic container stores from about 50 g to about 500 g of the pest control composition.
Paragraph 17. The aerosol pest control product according to any one of Paragraphs 1-16, wherein the plastic container comprises, consists essentially of, or consists of polyethylene terephthalate.
Paragraph 18. A method of controlling a pest comprising the steps of: (i) providing a pest control product according to any one of Paragraphs 1-17; (ii) dispensing the pest control product and contacting the pest with the pest control composition; (iii) optionally wiping any excess pest control composition from an adjacent surface(s).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An aerosol pest control product comprising:
a. a spray dispenser connected to a pressurized plastic container having an internal gage pressure of from about 414 kPa to about 1,100 kPa;
b. a pest control composition contained in the plastic container and comprising:
i. from about 1% to about 15% by weight of the composition of sodium lauryl sulfate;
ii. from about 0.005% to about 15%, by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof;
iii. from about 0.1% to about 45% by weight of the composition of a first solvent, wherein the first solvent is isopropyl alcohol;
iv. from about 45% to about 99% by weight of the composition of water; and
v. a propellant chosen from nitrogen, carbon dioxide, or mixtures thereof.

2. The aerosol pest control product of claim 1, wherein the plastic container has a light transmittance of greater than about 25% at a wavelength of about 410 nm to about 800 nm.

3. The aerosol pest control product of claim 1, wherein the pest control composition further comprises from about 0.1% to about 10% by weight of the composition of a second solvent selected from the group consisting of triethyl citrate, isopropyl myristate, propylene carbonate, ethyl lactate, butyl lactate, butyl stearate, glycerin, and mixtures thereof.

4. The aerosol pest control product of claim 1, wherein the pest control composition comprises from about 0.5% to about 10% by weight of the composition of an active ingredient selected from the group consisting of geraniol, cornmint oil, peppermint oil, rosemary oil, lemongrass oil, and mixtures thereof.

5. The aerosol pest control product claim 1, wherein the weight ratio of sodium lauryl sulfate to active ingredient is from about 1:1 to about 20:1.

6. The aerosol pest control product of claim 3, wherein the composition further comprises a carboxylic acid selected from the group consisting of citric acid, malic acid, acetic acid, fumaric acid, humic acid, salts thereof, and mixtures thereof.

7. The aerosol pest control product of claim 6, wherein the composition has a pH of about 3 to about 9.

8. The aerosol pest control product of claim 1, wherein the composition has a Brookfield viscosity of from about 1 cps to about 500 cps.

9. The aerosol pest control product of claim 1, wherein the plastic container comprises polyethylene terephthalate.

10. An aerosol pest control product comprising:
a. a spray dispenser connected to a pressurized plastic container having an internal gage pressure of from about 414 kPa to about 1,100 kPa;
b. a pest control composition contained in the plastic container and comprising:
i. from about 1% to about 15% by weight of the composition of sodium lauryl sulfate;
ii. from about 0.005% to about 15%, by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof;
iii. from about 0.1% to about 45% by weight of the composition of a first solvent, wherein the first solvent is isopropyl alcohol;
iv. from about 45% to about 99% by weight of the composition of water; and
v. a propellant chosen from nitrogen, carbon dioxide, or mixtures thereof;
wherein the composition has a turbidity less than about 20 NTU and greater than about 0 NTU and a b* value of about 0 to about 5.

11. The aerosol pest control of claim 10, wherein the composition comprises from about 0.15% to about 15% by weight of the composition of an active ingredient selected from the group consisting of geraniol, cornmint oil, lemongrass oil, rosemary oil, and mixtures thereof.

12. The aerosol pest control product of claim 10, wherein the composition comprises from about 0.5% to about 5% by weight of the composition of cornmint oil.

13. The aerosol pest control product claim 10, wherein the weight ratio of sodium lauryl sulfate to active ingredient is from about 1:1 to about 20:1.

14. The aerosol pest control product of claim 10, wherein the composition comprises particles having an intensity mean particle size of from about 2 nm to about 100 nm, as measured according to the Particle Size Test Method.

15. The aerosol pest control product of claim 10, wherein the composition comprises from about 3% to about 35% by weight of volatile organic compound (VOC).

16. The aerosol pest control product of claim 10, wherein the composition is substantially free of synthetic pesticides, mineral oil, colorants, antifoam agents, or a combination thereof.

17. The aerosol pest control product of claim 10, wherein the plastic container comprises polyethylene terephthalate.

18. The aerosol pest control product of claim 17, wherein the plastic container has a light transmittance of greater than about 25% at a wavelength of about 410 nm to about 800 nm.

19. The aerosol pest control product of claim 18, wherein the plastic container stores from about 50 g to about 500 g of the pest control composition.

20. A method of controlling a pest comprising the steps of:
(i) providing a pest control product comprising:
a. a spray dispenser connected to a pressurized plastic container having an internal gage pressure of from about 414 kPa to about 1,100 kPa;
b. a pest control composition contained in the plastic container, wherein the pest control composition is an oil-water-emulsion comprising:
i. from about 1% to about 15% by weight of the composition of sodium lauryl sulfate;
ii. from about 0.005% to about 15%, by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof;
iii. from about 0.1% to about 45% by weight of the composition of a first solvent, wherein the first solvent is isopropyl alcohol;
iv. from about 45% to about 99% by weight of the composition of water; and
v. a propellant chosen from nitrogen, carbon dioxide, or mixtures thereof;
(ii) dispensing the pest control product and contacting the pest with the pest control composition;
wherein the pest control composition exhibits a Spray D(90) of from about 100 microns to 900 microns after dispensing from the spray dispenser.
